(19) United States
(12) Patent Application Publication
(10) Pub. No.: US 2023/0386475 A1
(43) Pub. Date: Nov. 30, 2023

(54) SYSTEMS AND METHODS OF TEXT TO AUDIO CONVERSION

(71) Applicant: Naro Corp., West Bloomfield, MI (US)

(72) Inventors: Max Florian Frenzel, Tokyo (JP); Todd Silverstein, Tokyo (JP); Lyle Patrick Stein, Toronto (CA)

(21) Appl. No.: 17/827,758

(22) Filed: May 29, 2022

(51) Int. Cl. G10L 17/04; G10L 17/02; G10L 13/08; G10L 25/93

(52) U.S. Cl. CPC G10L 17/04; G10L 17/02; G10L 13/08; G10L 25/93

(57) ABSTRACT

A text to speech system can be implemented by training artificial intelligence models directed to encoding speech characteristics into an audio fingerprint and synthesizing audio based on the fingerprint. The speech characteristics can include a variety of attributes that can occur in natural speech, such as speech variation due to prosody. Speaker identity can, but does not have to, also be used in synthesizing speech. A pipeline using an audio processing device can receive a video clip or a collection of video clips and generate a synthesized video with varying degrees of association with the received video. A user of the pipeline can enter customization to modify the synthesized audio. A trained encoder can generate a fingerprint and a synthesizer can generate synthesized audio based on the fingerprint.

### BACKGROUND

### Field

This application relates to the field of artificial intelligence, and more particularly to the field of speech and video synthesis, using artificial intelligence techniques.

### Description of Related Art

Current text to speech (TTS) systems based on artificial intelligence (AI) use clean and polished audio samples to train their internal AI models. Clean audio samples usually have correct grammar and contain minimal or reduced background noise. Non-speech sounds like coughs and pauses are typically eliminated or reduced. Clean audio in some cases is recorded in a studio setting with professional actors reading scripts in a controlled manner. Clean audio, produced in this manner and used to train AI models in TTS systems can be substantially different than natural speech, which can include incomplete sentences, pauses, non-verbal sounds, background noise, a wider and more natural range of emotional components (such as sarcasm, humorous tone) and other natural speech elements, not present in clean audio. TTS systems use clean audio for a variety of reasons, including better availability, closer correlation between the sounds in the clean audio and accompanying transcripts of the audio, more consistent grammar, tone or voice, and other factors that can make training AI models more efficient. At the same time, training AI models using clean data can limit the capabilities of a TTS system.

### SUMMARY

The appended claims may serve as a summary of this application.

### BRIEF DESCRIPTION OF THE DRAWINGS

FIG. 1 illustrates an example of an audio processing device (APD).

FIG. 2 illustrates a diagram of the APD where an unsupervised training approach is used.

FIG. 3 illustrates diagrams of various models of generating audio fingerprints.

FIG. 4 illustrates a diagram of an alternative training and using of an encoder and a decoder.

FIG. 5 illustrates a diagram of an audio and video synthesis pipeline.

FIG. 6 illustrates an example method of synthesizing audio.

FIG. 7 illustrates a method of improving the efficiency and accuracy of text to speech systems, such as those described above.

FIG. 8 illustrates a method of increasing the realism of text to speech systems, such as those described above.

FIG. 9 illustrates a method of generating a synthesized audio using adjusted fingerprints.

FIG. 10 is a block diagram that illustrates a computer system upon which one or more described embodiment can be implemented.

### DETAILED DESCRIPTION OF THE DRAWINGS

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Advancements in the field of artificial intelligence (AI) have made it possible to produce audio from a text input. The ability to generate text from audio or automatic transcription has existed, but the ability to generate audio from text opens up a world of useful applications. The described embodiments include systems and methods for receiving an audio sample in one language and generating a corresponding audio in a second language. In some embodiments, the original audio can be extracted from a video file and the generated audio in the second language can be embedded in the video, as if the speaker in the video spoke the words in the second language. The described AI models, not only produce the embedded audio to sound like the speaker, but also to include the speech characteristics of the speaker, such as pitch, intensity, rhythm, tempo and emotion, pronunciation, and others. Embodiments include a dataset generation process which can acquire and assemble multi-language datasets with particular sources, styles, qualities, and breadth for use in training the AI models. Audio datasets (and corresponding transcripts) for training AI models for speech processing, can include “clean audio,” where the speaker in the audio samples reads a script, without typical non-speech characteristics, such as pauses, variations in tone, emotions, humor, sarcasm, and the like. But the described training datasets can also include normal speech audio samples, which can include typical speech and non-speech audio characteristics, which can occur in normal speech. As a result, the described AI models can be trained in normal speech, increasing the applicability of the described technology, relative to systems that only train on clean audio.

Embodiments can further include AI models trained to receive training audio samples and generate one or more audio fingerprints from the audio samples. An audio fingerprint is a data structure encoding various characteristics of an audio sample. Embodiments can further include a text-to-speech (TTS) synthesizer, which can use a fingerprint to generate an output audio file from a source text file. In one example application, the fingerprint can be from a speaker in one language and the source text underlying the output audio can be in a second language. For example, a first speaker's voice in Japanese can yield an audio fingerprint, which can be used to generate an audio clip of the same speaker or a second speaker voice in English. Furthermore, in some embodiments, the fingerprints and/or the output audio are tunable and customizable, for example, the fingerprint can be customized to encode more accent and foreign character of a language into the fingerprint, so the output audio can retain the accent and foreign character encoded in the fingerprint. In other embodiments, the output audio can be tuned in the synthesizer, where various speech characteristics can be customized.

In some embodiments, the trained AI models during inference, operate on segments of incoming audio (e.g., each segment being a sentence or a phoneme, or any other segment of audio and/or speech), and produce output audio segments based on one or more fingerprints. An assembly process can combine the individual output audio segments into a continuous and coherent output audio file. In some embodiments, the assembled audio can be embedded in a video file of a speaker.

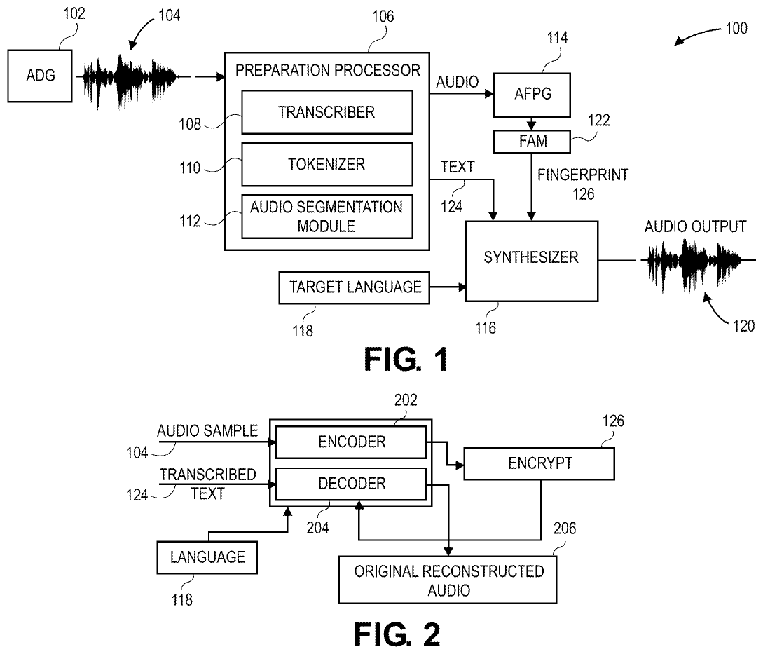

FIG. 1 illustrates an example of an audio processing device (APD) 100. The APD 100 can include a variety of artificial intelligence models, which can receive a source text file and produce a target audio file from the source text file. The APD 100 can also receive an audio file and synthesize a target output audio file, based or corresponding to the input audio file. The relationship between the input and output of the APD 100 depends on the application in which the APD 100 is deployed. In some example applications, the output audio is a translation of the input audio into another language. In other applications, the output audio is in the same language as the input audio with some speech characteristics modified. The AI models of the APD 100 can be trained to receive audio sample files and extract identity and characteristics of one or more speakers from the sample audio files. The APD 100 can generate the output audio to include the identity and characteristics of a speaker. The distinctions between speaker identity and speaker characteristics will be described in more detail below. Furthermore, the APD 100 can generate the output audio in the same language or in a different language than the language of the input data.

The APD 100 can include an audio dataset generator (ADG) 102, which can produce training audio samples 104 for training the AI models of the APD 100. The APD 100 can use both clean audio and also natural speech audio. Examples of clean audio can include speeches recorded in a studio with a professional voice actor, with consistent and generally correct grammar and reduced background noise. Some public resources of sample audio training data include mostly or nearly all clean audio samples. Examples of natural speech audio can include speech which has non-verbal sounds, pauses, accents, consistent or inconsistent grammar, incomplete sentences, interruptions, and other natural occurrences in normal, everyday speech. In other words, in some embodiments, the ADG 102 can receive audio samples in a variety of styles, not only those commonly available in public training datasets.

In some embodiments the ADG 102 can separate the speech portions of the audio from the background noise and non-speech portions of the audio and process the speech portions of the audio sample 104 through the remainder of the APD 100. The audio samples 104 can be received by a preparation processor 106. The preparation processor 106 can include sub-components, such as an audio segmentation module 112, a transcriber 108, and a tokenizer 110. The audio segmentation module 112 can slice the input audio 104 into segments, based on sentence, phoneme, or any other selected units of speech. In some embodiments, the slicing can be arbitrary or based on a uniform or standard format, such as international phonetic alphabet (IPA). The transcriber 108 can provide automated, semi-automated or manual transcription services. The audio samples 104 can be transcribed using the transcriber 108. The transcriber can use placeholder symbols for non-speech sounds present in the audio sample 104. A transcript generated with placeholder symbols for non-speech sounds can facilitate the training of the AI models of the APD 100 to more efficiently learn a mapping between the text in the transcript and the sounds present in the audio sample 104.

In some embodiments, sounds that can be transcribed, using consistent characters that nearly match the sounds phonetically, can be transcribed as such. An example includes the sound “umm.” Such sounds can be transcribed accordingly. Non-speech sounds, such as coughing, laughter, or background noise can be treated by introducing placeholders. As an example, any non-speech sound can be indicated by a placeholder character (e.g., delta in the transcript can indicate non-verbal sounds). In other embodiments, different placeholder characters can be used for different non-verbal sounds. The placeholders can be used to signal to the models of the APD 100 to not try to wrongly associate non-verbal sounds flagged by placeholder characters with speech audio. This can reduce or minimize the potential for the models of the APD 100 to learn wrong associations and increases the training efficiency of these models. As will be described in some embodiments, during inference operations of the models of the APD 100, the non-verbal sounds from a source audio file can be extracted and spliced into a generated target audio. The transcriber module can also include any further metadata about training or inference data samples which might aid in better training or inference in the models of the APD 100. Example meta data can include type of language, emotion, or any speech attributes, such as whisper, shout, etc.

The preparation processor 106 can also include a tokenizer 110. The APD 100 can use models that have a dictionary or a set of characters they support. Each character can be assigned an identifier (e.g., an integer). The tokenizer 110 can convert transcribed text from the transcriber 108 into a series of integers through a character to identifier mapping. This process can be termed “tokenizing.” In some embodiments, the APD 100 models process text in the integer series representation, learning an embedding vector for each character. The tokenizer 110 can tokenize individual letters in a transcript or can tokenize phonemes. In a phoneme-based approach, the preparation processor 106 can covert text in a transcript to a uniform phonetic representation of international phonetic alphabet (IPA) phonemes.

When individual roman character letters are tokenized, a normalization preprocess can be performed, which can include converting numbers to text, expanding number enumerated dates into text, expanding abbreviations into text, converting symbols into text (e.g., “&” to “and”), removing extraneous white spaces and/or characters that do not influence how a language is spoken (e.g., some brackets). For non-Roman languages, such as Japanese, the normalization preprocess can include converting symbols into canonical form prior to Romanization. Such languages can also be Romanized before tokenization.

The APD 100 includes an audio fingerprint generator (AFPG) 114, which can receive an audio file, an audio segment and/or an audio clip and generate an audio fingerprint 126. The AFPG 114 includes one or more artificial intelligence models, which can be trained to encode various attributes of an audio clip in a data structure, such as a vector, a matrix or the like. Throughout this description audio fingerprint can be referred to in terms of a vector data structure, but persons of ordinary skill in the art can use a different data structure, such as a matrix with similar effect. Once trained, the AI models of the AFPG 114 can encode both speaker identity as well as speaker voice characteristics into the fingerprint. The term speaker identity in this context refers to the invariant attributes of a speaker's voice. For example, AI models can be trained to detect the parts of someone's speech which do not change, as the person changes the tone of their voice, the loudness of their voice, humor, sarcasm or other attributes of their speech. There remain attributes of someone's speech and voice that are invariant between the various styles of the person's voice. The AFPG 114 models can be trained to identify and encode such invariant attributes into an audio fingerprint. There are, however, attributes of someone's voice that can vary as the person changes the style of their voice (which can be related to the content of their speech). A person's voice style can also change based on the language the person is speaking and the character of the language spoken as employed by the speaker. For example, the same person can employ various different speech attributes and characteristics when the same person speaks a different language. Additionally, languages can evoke different attributes and styles of speech in the same speaker. These variant sound attributes can include prosody elements such as emotions, tone of voice, humor, sarcasm, emphasis, loudness, tempo, rhythm, accentuation, etc. The AFPG 114 can encode non-identity and variant attributes of a speaker into an audio fingerprint. A diverse fingerprint, encoding both invariant and variant aspects of a speaker's voice can be used by a synthesizer 116 to generate a target audio from a text file, mirroring the speech attributes of the speaker more closely than if a fingerprint with only the speaker identity data were to be used. Furthermore, the described techniques are not limited to the input/output corresponding to a single speaker. The input can be from the speech of one speaker and the synthesized output audio can be any arbitrary speech, with the speech attributes and characteristics of the input speaker.

Some AI models, that extract speaker attributes from sample audio clips, strip out all information that can vary within the voice of a speaker. In such systems, regardless of what input audio samples from the same speaker is used, the output always maps to the same fingerprint. In other words, these models can only encode speaker identity in the output fingerprint. In described embodiments, more versatility in the audio fingerprint can be achieved by encoding speech characteristics, including the variant aspect of the speech in the output fingerprint. In one approach, the training of the AFPG models can be supplemented by adding prosody identification tasks to the speaker identification tasks and optimizing the joint loss, potentially with different weights to control the relative importance and impact of identity and/or characteristics on the output fingerprint.

In one embodiment, during training a model of the AFPG, the model can be given individual audio clips and configured to generate fingerprints for the clips that include speaker identity as well as prosody variables. This configures the model to not discard prosody information but also to encode them in the output audio fingerprint alongside the speaker identity. Such prosody variables can be categorical, similar to the speaker identity, but they can also be numerical (e.g., tempo on a predefined scale).

The AFPG model can be configured to distribute both the speaker identity and prosody information across the output fingerprint, or it can be configured to learn a disentangled representation of speaker identity and prosody information, where some dimensions of the output fingerprint are allocated to encode identity information and other dimensions are allocated to encode prosody variables. The latter can be achieved by feeding some subspaces of the full fingerprinting vector into AI prediction tasks. For example, if the full fingerprinting includes 512 dimensions, the first 256 dimensions can be allocated for encoding the speaker identification task and the latter 256 dimensions can be allocated to encode the prosody prediction tasks, disentangling speaker and prosody characteristics across the various dimensions of the fingerprint vector. The prosody dimensions can further be broken down across various categories of prosody information, for example, 4 dimensions can be used for tempo, 64 dimensions for emotions, and so forth. The categories can be exclusive or overlapping. If exclusive categories are used, the speech characteristics can be fully disentangled, and potentially allow for greater fine-control in the synthesizer 116 or other downstream operations of the APD 100. Overlapping some categories in fingerprint dimensions can also be beneficial since speech characteristics may not be fully independent. For example, emotion, loudness, and tempo are separate speech characteristics categories, but they tend to be correlated to some extent. The fingerprint dimensions do not need to necessarily be understood or even sensical in terms of human-definable categories. That is, in some embodiments, the fingerprint dimensions can have unique and/or overlapping meanings understood only to the AI models of the APD 100, in ways that cannot be quantifiable and/or definable by a human user operating the APD 100. For example, there may be 64 fingerprint dimensions that encode tempo, but not known which fingerprint dimensions encompass them. Or in some embodiments, the fingerprint dimensions may overlap, but the overlapping dimensions and the extent of the overlap need not to be defined or even understandable by a human. The details of the correlation and break-up the various dimensions of the fingerprint relative to speech characteristics, categories and their overlap can depend on the particular application and/or domain in which the APD 100 is deployed.

### Synthesizer 116

In some embodiments, the synthesizer 116 can be a text to speech (TTS), or text to audio system, based on AI models, such as deep learning networks that can receive a text file 124 or a text segment, and an audio fingerprint 126 (e.g., from the AFPG 114) and synthesize an output audio 120 based on the attributes encoded in the audio fingerprint 126. The synthesized output audio 120 can include both invariant attributes of speech encoded in the fingerprint (e.g., speaker identity), as well as the variant attributes of speech encoded in the fingerprint (e.g., speech characteristics). In some embodiments, the synthesized output audio 120 can be based on only one of the identity or speech characteristics encoded in the fingerprint.

The synthesizer 116 can be configured to receive a target language 118 and synthesize the output audio 120 in the language indicated by the target language 118. Additionally, the synthesizer 116 can be configured to perform operations, including synthesis of speech for a speaker that was or was not part of the training data of the models of the AFPG 114 and/or the synthesizer 116. The synthesizer 116 can perform operations including, multilanguage synthesis, which can include synthesis of a speaker's voice in a language other than the speaker's original language (which may have been used to generate the text file 124), voice conversion, which can include applying the fingerprint of one speaker to another speaker, among other operations. In some embodiments, the preparation processor 106 can generate the text 124 from a transcription of an audio sample 104. If the output audio 120 is selected to be in a target language 118 other than the input audio language, the preparation processor 106 can perform translation services (automatically, semi-automatically or manually) to generate the text 124 in the target language 118.

The APD 100 can be used in instances where the input audio samples 104 can include multiple speakers, speaking multiple languages, multiple speakers speaking the same language, single speaker speaking multiple languages, and single speaker speaking a single language. In each case, the preparation processor 106 or another component of the APD 100 can segment the audio samples 104 by some unit of speech, such as one sentence at a time or one word at a time, or one phoneme at the time, or based on IPA or any other division of the speech and apply the models of the APD 100. The particulars of the division and segmentation of speech at this stage can be implemented in a variety of ways, without departing from the spirit of the disclosed technology. For example, the speech can be segmented based on a selected unit of time, based on some characteristics of the video from which the speech was extracted, or based on speech attributes such as loudness, etc. or any other chosen unit of segmentation, variable, fixed or a combination. Listing any particular methods of segmentation of speech does not necessarily exclude other methods of segmentation. In the case of single speaker, single language, the APD 100 can offer advantages, such as an ability to synthesize additional voice-over narration, without having to rerecord the original speaker, synthesize additional versions of a previous recording, where audio issues were present or certain edits to speech is desired, synthesizing arbitrary length sequences of speech for lip syncing and other advantages. The advantages of single or multiple speakers and multiple languages can include translation of an input transcript and synthesis of an audio clip of the transcript from one language to another.

### Synthesis Using Speaker Identity

Speaker identity in this context refers to the invariant attributes of speech in an audio clip. The AI models of the synthesizer 116 can be trained to synthesize the output audio 120, based on the speaker identity. During training, each speaker can be assigned a numeric identifier, and the model internally learns an embedding vector associated with each speaker identifier. The synthesizer models receive as input conditioning parameters, which in this case can be a speaker identifier. The synthesizer models then through the training process configure their various layers to produce an output audio 120 that matches a speaker's voice that was received during training, for example via the audio samples 104. If the synthesizer 106 only uses speaker identity, the AFPG 114 can be skipped, since no fingerprint for a speaker is learned or generated. An advantage of this approach is ease of implementation and that the synthesizer models can internally learn which parameters are relevant to generating a speech similar to a speech found in the training data. A disadvantage of this approach is that the synthesizer models trained in this manner cannot efficiently perform zero-shot synthesis, which can include synthesizing a speaker's voice that was not present in the training audio samples. Furthermore, if the number of speakers changes or new speakers are introduced, the synthesizer models may have to be reinitialized and relearn the new speaker identities. This can lead to discontinuity and some unlearning. Still, the synthesis with only speaker identity can be efficient in some applications, for example if the number of speakers is unchanged and a sufficient amount of training data for a speaker is available.

### Synthesis Using Speaker Fingerprint

In some embodiments, rather than training the model to internally learn a dynamic vector representation for each speaker in the training audio samples 104, fingerprints or vector representations generated by a dedicated and separate system, such as the AFPG 114, can be directly provided as input or inputs to the models of the synthesizer 116. The AFPG 114 fingerprints or vector representations can be generated for each speaker in the training audio samples 104, which can improve continuity across a speaker, when synthesizing the output audio 120. Fingerprinting for each speaker can allow the output audio 120 to represent not only the overall speaker identity, but also speech characteristics, such as speed, loudness, emotions, etc., which can vary widely even within the speech of a single speaker.

During the inference operations of the synthesizer 116, a fingerprint associated with particular speaker can be selected from a single fingerprint, or through an averaging operation or via other combination methods to generate a fingerprint 126 to be used in the synthesizer 116. The synthesizer 116 can generate the output audio by applying the fingerprint 126. This approach can confer a number of benefits. Rather than learning a fixed mapping between a speaker and the speaker identity, the synthesizer 116 models receive a unique vector representation (fingerprint) for each training example (e.g., audio samples 104). As a result, the synthesizer 116 learns a more continuous representation of a speaker's speech, including both identity and characteristics of the speech of the speaker. Furthermore, though a particular point in the high-dimensional fingerprint space was not seen in training, the synthesizer 116 can still “imagine” what such a point might sound like. This can enable zero-shot learning, which can include the ability to create a fingerprint for a new speaker that was not present in the training data and conditioning the synthesizer on a fingerprint generated for an unknown speaker. In addition, this approach allows for changing the number and identity of speakers across consecutive training runs without having to re-initialize the models.

In one example, assuming the same AFPG 114 models are being used, the model is exposed to different aspects of the same large fingerprint space, filling in gaps of its previous knowledge where it may only otherwise fill by interpolation. This approach allows for a more staged approach to training, and fine-tuning possibilities, without risking strong unlearning by the model because of discontinuities in speaker identities. Furthermore, the fingerprinting approach is not limited to only encoding speaker identity in a fingerprint. Without any or substantial changes to the architecture of the models of the synthesizer 116, the synthesizer 116 can be used to produce output audio based on other speech attributes, such as emotion, speed, loudness, etc. when the synthesizer 116 can receive fingerprints that encode such data. In some embodiments, fingerprints can be encoded with speech characteristics data, such as prosody by concatenating additional attribute vectors to the speaker identity fingerprint vector, or by configuring the AFPG 114 to also encode additional selected speech characteristics into the fingerprint.

### Multilanguage Capability

In some embodiments, the ability of the APD 100 to receive audio samples in one language and produce synthesized audio samples in another language can be achieved in part by including a language embedding layer in the models of the AFPG 114 or the synthesizer 116. Similar to internal speaker identity embedding, each language can be assigned an identifier, which the models learn to encode into a vector (e.g., a fingerprint vector from the AFPG 114, or an internal embedding vector in the synthesizer 116). In some embodiments, the language vector can be an independent vector or it can be a layer in the fingerprint 126 or the internal embedding vector of the synthesizer 116. The language layer or vector is subsequently used during inference operations of the ADP 100.

### Improved Audio Fingerprint Generation

Encoding prosody information in addition to speaker identity into fingerprints opens up a number of control possibilities for the downstream tasks in which the fingerprints can be used, including in the synthesizer 116. In one application, during inference operations, an audio sample 114 and selected speech characteristics, such as prosody characteristics, can be used to generate a fingerprint 126. The synthesizer 116 can be configured with the fingerprint 126 to generate a synthesized output audio 120. If different regions of the fingerprint 126 are configured to encode different prosody characteristics, which are also disentangled from the speaker identity regions of the fingerprint, it is possible to provide multiple audio samples 104 to the APD 100 and generate a conditioning fingerprint 126 by slicing and concatenating the relevant parts from the different individual fingerprints, e.g. speaker identity from one audio sample 104, emotion from a second audio sample 104 and tempo from a third audio sample 104 and other customization and combinations in generating a final fingerprint 126.

Beyond providing representative audio samples from an enhanced fingerprint, having subspaces encoding speech characteristics in the fingerprint offers further fine control opportunities over the conditioning of the synthesizer 116. Such fingerprint subspaces can be varied directly by manipulating the higher dimensional space (e.g., by adding noise for getting more variation in the characteristic encoded in a subspace). In addition, by defining a bi-directional mapping between a subspace and a one- or two-dimensional compressed space (for example, using a variational autoencoder), the characteristic corresponding to the subspace can be presented to a user of the APD 100 with a user interface (UI) dashboard to manipulate or customize, for example via pads, sliders or other UI elements. In this example, the conditioning fingerprint can be seeded through providing a representative audio sample (or multiple, using the slicing and concatenating process described above), and then individual characteristics can be further adjusted by a user through UI elements, such as pads and sliders. Input/Output of such UI elements can be generated/received by a fingerprint adjustment module (FAM) 122, which can in turn configure the AFPG 114 to implement the customization received from the user of the APD 100. The FAM 122 can augment the APD 100 with additional functionality. For example, in some embodiments, the APD 100 can provide multiple outputs to a human editor and obtain a selection of a desirable output from the human editor. The FAM 122 can track such user selection over time and provide the historical editor preference data to the models of the APD 100 to further improve the models' output with respect to a human editor. In other words, the FAM 122 can track historical preference data and condition the models of the APD 100 accordingly. Furthermore, the FAM 122 can be configured with any other variable or input receivable from the user or observable in the output from which the models of the APD 100 may be conditioned or improved. Therefore, examples provided herein as to applications of the FAM 122 should not be construed as the outer limits of its applicability.

Another example application of user customization of a fingerprint can include improving or modifying a previously recorded audio sample. For example, in some audio recordings, the speaker's performance may be overall good but not desirable in a specific characteristic, for example, being too dull. Encoding the original performance in a fingerprint, and then adjusting the relevant subspace of the fingerprint from, for example, dull to vivid/cheery, or from one characteristic to another, can allow recreating the original audio with the adjusted characteristics, without the speaker having to rerecord the original audio.

Unsupervised Method of Training and Using AFPG and/or Synthesizer

The fingerprinting techniques described above offer a user of the APD 100 the ability to control the speech characteristics reflected in the synthesized output audio 120. In some embodiments, labeled training data with known or selected audio characteristics is used to train the AFPG 114 in the prediction tasks. However, in alternative embodiments, an unsupervised training approach can also be used. FIG. 2 illustrates a diagram of the APD 100 when an unsupervised training approach to training and using the AFPG 114 and/or the synthesizer 116 is used. In this approach, the AFPG 114 can include an encoder 202 and a decoder 204. The encoder 202 can receive an audio sample 104 and generate a fingerprint 126 by encoding various speech characteristics in the fingerprint 126. The audio sample 104 can be received by the encoder 202 after processing by the preparation processor 106. The decoder 204 can receive the fingerprint 126, as well as a transcription of the audio sample 104 and a target language 118. In the unsupervised training approach, the transcribed text 124 is a transcription of the audio sample 104 that was fed into the encoder 202. The decoder 204 reconstructs the original audio sample 104 from the transcribed text 124 and the fingerprint 126.

In this approach, during each training step, the AFPG 114 generates the fingerprint 126, which the decoder 204 converts back to an audio clip. The audio clip is compared against the input sample audio 104 and the models of the AFPG 114 and/or the decoder 204 are adjusted (e.g., through a back-propagation method) until the output audio 206 of the decoder 204 matches or nearly matches the input sample audio 104. The training steps can be repeated for large batches of audio samples. During inference operations, the fingerprint 126 corresponding a near match output audio 206 to input audio sample 104 is outputted as fingerprint 126 and can be used in the synthesizer 116. In other words, during inference operations, the operation of the decoder 204 can be skipped. Feeding the transcribed text 124 and the target language 118 to the decoder has the advantage of training the encoder/decoder system to disentangle the text and language data from the fingerprint and only encode the fingerprint with information that is relevant to reproducing the original audio sample 104, when the text and language data may otherwise be known (e.g., in the synthesizer stage). As described, in this unsupervised approach, during inference operations, only the encoder part of the AFPG 114 is used to create the fingerprint from an input audio sample 104.

In an alternative approach, the AFPG 114 can be used as the encoder 202 and the synthesizer 116 can be used as the decoder 204. An example application of this approach is when an audio sample 104 (before or after processing by preprocessor 106) is available and a selected output audio 206 is a transformed (e.g., translated) version of the audio sample 104. In this scenario, the training protocol can be as follows. The model or models to be trained are a joint system of the encoder 202 and the decoder 204 (e.g., the AFPG 114 and the synthesizer 116). The encoder 202 is fed the original audio sample 104 as input and can generate a compressed fingerprint 126 representation, for example, in the form of a vector. The fingerprint 126 is then fed into the decoder 204, along with a transcript of the original audio sample 104, and the target language 118. The decoder 204 is tasked with reconstructing the original audio sample 104. Jointly optimizing the encoder 202/decoder 204 system will configure the model or models therein to encode in the fingerprint 126, as much data about the overall speech in the audio sample 104 as possible, excluding the transcribed text 124 and the language 118, since they are inputted directly to the decoder 204, instead of being encoded in the fingerprint 126. During inference operations, in order to generate speech fingerprints 126 from a trained model, the decoder 204 can be discarded and only the encoder 202 is used. However, during inference operations, once the final fingerprint 126 is generated, the decoder 204 can be fed any arbitrary text 124 in the target language 118 and can generate the output audio 120 based on the final fingerprint 126.

This approach may not provide a disentangled representation of speech characteristics, but can instead, provide a rich speech fingerprint, which can be used to condition the synthesizer 116 more closely on the characteristics of a source audio sample 104, when generating an output audio 120. The AFPG systems and techniques described in FIG. 2 can be trained in an unsupervised fashion, requiring few to no additional information beyond what may be used for training the synthesizer 116. Compared to supervised training methods, the AFPG system of FIG. 2 can be deployed when training audio samples with labeled prosody data may be sparse. In this approach, the AFPG 114 models can internally determine which speech characteristics are relevant for accurately modeling and reconstructing speech and encode them in the fingerprint 126, beyond any preconceived human notions such as “tempo”. Information that is relevant to speech reconstruction is encoded in the fingerprint, even if there is no human-defined parameter or category can be articulated or programmed in a computer for such speech characteristics that are intuitively obvious to humans. In tasks, where sample audio which contains the desired speaker and prosody information is available, such as translating a speaker's voice into a new language, without changing the speaker identity or speech characteristics, the unsupervised system has the advantage of not having to be trained with pre-defined or pre-engineered characteristics of interest.

### Speaker Similarity and Clustering

Enhanced audio fingerprints can offer the advantage of finding speakers having similar speech identity and/or characteristics. For example, vector distances between two fingerprints can yield a numerical measure of similarity or dissimilarity of two fingerprints. Same technique can be used for determining subspace similarity level between two fingerprints. Not only can speakers be compared and clustered into similar categories based on their overall speech similarity, but also based on their individual prosody characteristics. In the context of the APD 100 and other speech synthesis pipelines using the APD 100, when a new speaker is to be added to the pipeline or some of the models therein, the fingerprint similarity technique described above can be used to find a fingerprint with a minimum distance to the fingerprint of the new speaker. The pre-configured models of the pipeline, based on the nearby fingerprint can be used as a starting point for reconfiguring the pipeline to match the new speaker. Computing resources and time can be conserved by employing the clustering and similarity techniques described herein. Furthermore, various methods distance measurement can be useful in a variety of applications of the described technology. Example measurements include Euclidean distance measurements, cosine distance measurements and others.

A similar process can also be used to analyze the APD 100's experience level with certain speakers and use the experience level as a guideline for determining the amount of training data applicable for a new speaker. If a new speaker falls into a fairly dense pre-exiting cluster, with lots of similar sounding speakers being present in the past training data, it is likely that less data is required to achieve good training/fine-tuning results for the new speaker. If, on the other hand, the new speaker's cluster is sparse or the nearest similar speakers are distant, more training data can be collected for the new speaker to be added to the APD 100.

Fingerprint clustering can also help in a video production pipeline. Recorded material can be sorted and searched by prosody characteristics. For example, if an editor wants to quickly see a collection of humorous clips, and the humor characteristic is encoded in a subspace of the fingerprint, the recorded material can be ranked by this trait.

### Speaker Identification Using Fingerprints

A threshold distance can be defined between a reference fingerprint for each speaker and a new fingerprint. If the distance falls below this threshold, the speaker corresponding to the new fingerprint can be identified as identical to the speaker corresponding to the reference fingerprint. Applications of this technique can include identity verification using speaker audio fingerprint, tracking an active speaker in an audio/video feed in a group setting in real time, and other applications.

In the context of video production pipelines using the APD 100 speaker identification, using fingerprint distancing, can be useful in the training data collection phase. As material is being recorded, from early discussions about the production, to interviews, and the final production, the material is likely to contain multiple voices, whose data can be relevant and desired for training purposes. The method can also be used for identifying and isolating selected speakers for training purposes and/or detecting irrelevant speakers or undesired background voices to be excluded from training. Automatic speaker identification based on speaker fingerprints can be used to identify and tag speech of selected speaker(s).

### Methods of Generating Audio Fingerprints

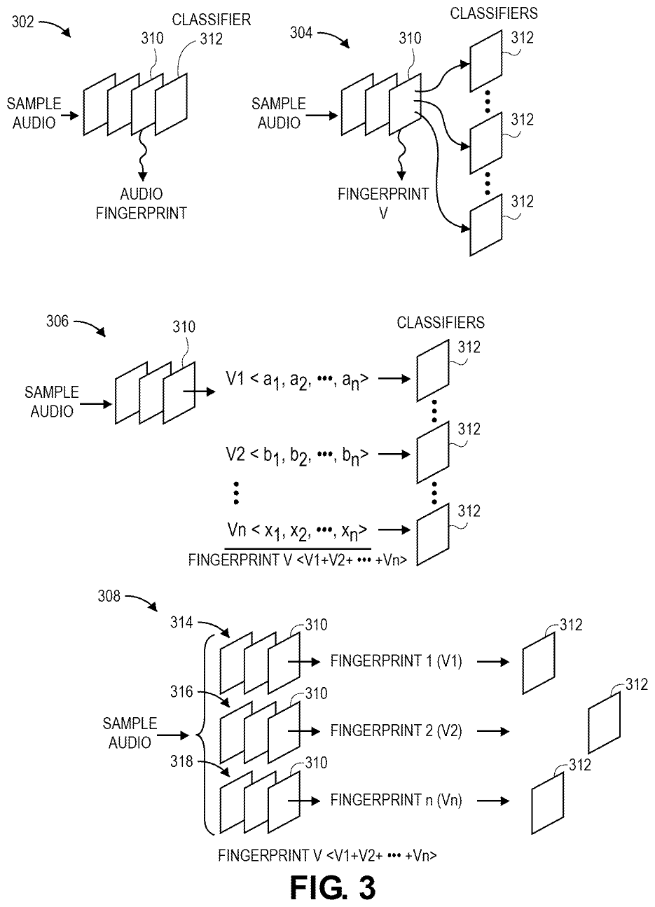

FIG. 3 illustrates diagrams of various models of generating audio fingerprints, using AI models. In the model 302, sample audio is received by an AI model, such as a deep learning network. The model architecture can include an input layer, one or more hidden layers and an output layer. In some embodiments, the output layer 312 can be a classifier tasked with determining speaker identity. In the model 302, the output of the last hidden layer, layer 310, can be used as the audio fingerprint. In this arrangement, the model 302 is configured to encode the audio fingerprint with speech data that is invariant across the speech of a single speaker but varies across the speeches of multiple speakers. Consequently, fingerprint generated using the model 302 is more optimized for encoding speaker identity data.

In the models 304 and 306, additional classifiers 312 can be used. For both 304 and 306, the fingerprint vector V can still be generated from the last hidden layer, layer 310. In the model 304, the output of the last hidden layer 310 is fed entirely into multiple classifiers 312, which can be configured to encode overlapping attributes of the speech into the fingerprint V. These attributes can include speaker identity, encompassing the invariant attributes of the speech within a single speaker's speech, as well as speech characteristics or the variant attributes of the speech within a single speaker's speech, such as prosody data. In effect, the model 304 can encode an audio fingerprint vector by learning a rich expression with natural correlation between the speaker's identity, characteristics and the dimensions encoded in the fingerprint.

In the model 306, the output of the last hidden layer 310 or the fingerprint V can be split into distinct sub-vectors, V1, V2, Vn. Each sub-vector Vn can correspond to a sub-space of a speech attribute. Each sub-vector can be fed into a distinct or overlapping plurality of classifiers 312. Therefore, the dimensions of the fingerprint corresponding to each speech characteristics can be known and those parameters in the final fingerprint vector can be manipulated automatically, semi-automatically or by receiving a customization input from the user of the APD 100. For example, a user can specify “more tempo” in the synthesized output speech via a selection of buttons and/or sliders. The user input can cause the parameters corresponding to tempo in the final fingerprint vector V to be adjusted accordingly, such that an output audio synthesized from the adjusted fingerprint would be of a faster tempo, compared to an input audio sample. Referring to FIG. 1, receiving user customization input and adjusting a fingerprint vector can be performed via a fingerprint adjustment module (FAM) 122. The adjusted fingerprint is then provided to the synthesizer 116 to synthesize an output video accordingly. In this manner, the model 306 can learn a disentangled representation of various speech characteristics, which can be controlled by automated, semi-automated or manual inputs.

Speech characteristics can be either labeled in terms of discrete categories, such as gender or a set of emotions, or parameterized on a scale, and can be used to generate fingerprint sub-vectors, which, can in turn, allow control over those speech characteristics in the synthesized output video, via adjustments to the fingerprint. Example speech characteristics adjustable with the model 306 include, but are not limited to, characteristics such as: tempo and pitch relative to a speaker's baseline, and vibrato. The sub-vectors or subspaces corresponding to characteristics, categories and/or labels do not need to be mutually exclusive. An input training audio sample can be tagged with multiple emotion labels, for example, or tagged with a numeric score for each of the emotions.

When the output of the last hidden layer 310 is fed entirely into the different classifiers 312, as is done in the model 304, speech characteristics encoded in the fingerprint V are overlapping and/or entangled since the information representing these characteristics are spread across all dimensions of the fingerprint. If the output of the last hidden layer 310 is split up on the other hand, and each distinct split fed into a unique classifier 312, as is done in the model 306, only that classifier's characteristics will be encoded in the associated hidden layer sub-space, leading to a fingerprint with distinct and/or disentangled characteristics. In other words, the architecture of the model 304 can lead to encoding overlapping and/or entangled attributes in the fingerprint V, while the architecture of the model 306 can lead to encoding distinct and/or disentangled attributes in the final fingerprint.

The model 308 outlines an alternative approach where separate and independent encoders or AFPGs can be configured for each speech characteristics or for a collection of speech characteristics. In the model 308, the independent encoders 314, 316 and 318 can be built using multiple instances of the model 302, as described above. While three encoders are shown fewer or more encoders are possible. Each encoder can be configured to generate a fingerprint corresponding to a speech characteristic from its last hidden layer, layer 310, but each encoder can be fed into a different classifier 312. For example, one encoder can be allocated and configured for generating and encoding a fingerprint with speaker identity data, while other encoders can be configured to generate fingerprints related to speech characteristics, such as prosody and other characteristics. The final fingerprint V can be a concatenation of the separate fingerprints generated by the multiple encoders 314, 316 and 318. Similar to the model 306, the dimensions of the final fingerprint corresponding to speech characteristics and/or speaker identity are also known and can be manipulated or adjusted in the same manner as described above in relation to the model 306.

In some embodiments, the classifiers 312 used in models 302, 304, 306 and 308 can perform an auxiliary task, used during training, but ignored during inference. In other words, the models can be trained as classifier models, where no audio fingerprint vector from the last hidden layer 310 is extracted during training operations, while during inference operations, audio fingerprint vectors are extracted from the last hidden layer 310, ignoring the output of the classifiers. Using this technique, categorical labelled data can be used to train the models of the APD 100, but the training also conditions the models to learn an underlying continuous representation of audio, encoding into an audio fingerprint, audio characteristics, which are not necessarily categorical. This rich and continuous representation of audio can be extracted from the last hidden layer 310. Other layers of the models can also provide such representation by various degrees of quality.

### Hybrid Approach

As described above, the unsupervised training approach discussed above has the advantage of being able to encode undefined speech characteristics into an audio fingerprint, including those speech characteristics that are intuitively recognizable by human beings when hearing speech, but are not necessarily articulable. At the same time, encoding definable and categorizable speech characteristics into a fingerprint and/or synthesizing audio using such definable characteristics can also be desirable. In these scenarios, a hybrid approach to training and inference may be applied.

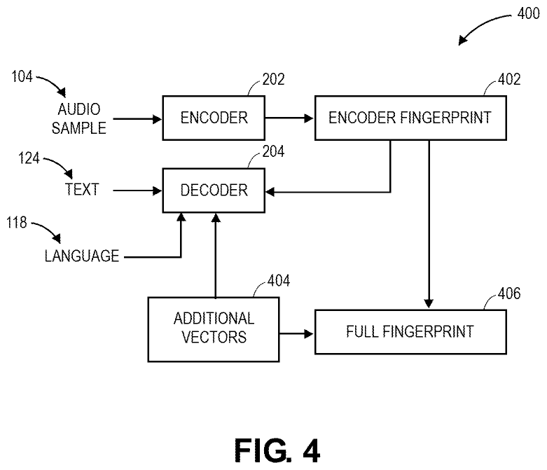

FIG. 4 illustrates a diagram 400 of an alternative training and use of the encoder 202 and decoder 204, previously described in relation to the embodiment of FIG. 2. In this approach, similar to the embodiment of FIG. 2, audio samples 104 are provided to the encoder 202, which the encoder 202 uses to generate the encoder fingerprint 402. The encoder fingerprint 402 is fed into the decoder 204, along with the text 124 and the language 118. In this approach, the decoder 204 is also fed additional vectors 404, generated from the audio samples 104, based on or more of the models in the embodiments of FIG. 3. In this approach, the encoder 202 does not have to learn to encode the particular information encoded in the additional vectors 404 in the encoder fingerprint 402. The full fingerprint 406 is generated by combining the encoder fingerprint 402 and the additional vectors 404, which were previously fed into the decoder 204.

The additional vectors 404 can include an encoding of a sub-group of definable speech characteristics, such as those speech characteristics that can be categorized or labeled. The additional vectors 404 are not input into the encoder 202 and do not become part of the output of the encoder 202, the encoder fingerprint 402. The approach illustrated in the diagram 400 can be used to configure the encoder 202 to encode the speech data most relevant to reproducing speech, with matching or near-matching to an input audio sample 104, including those speech characteristics that are intuitively discernable, but not necessarily articulable. In some embodiments, the encoder fingerprint 402 can include the unconstrained speech characteristics (the term unconstrained referring to unlabeled or undefined characteristics). Concatenating the encoder fingerprints 402 from the encoder 202 with the additional vectors 404 can yield the full fingerprint 406, which can be used to synthesize an output audio 120. The encoder fingerprints 402 and additional vectors 404 can be generated by any of the models described above in relation to the embodiments of FIG. 3. For example, the additional vectors 404 can be embedded in a plurality of densely encoded vectors in a continuous space, where emotions like, “joy” and “happiness” are embedded in vectors or vector dimensions close together and further from emotions, such as “sadness” and “anger,” or the additional vectors 404 can be embedded in a single vector with allocated dimensions to labeled speech characteristics. For example, for a speech characteristic with three possible categories, “normal,” “whisper,” and “shouting,” three distinct dimensions of a fingerprint vector can be allocated to these three categories. The other dimensions of the fingerprint vector can encode other speech characteristics (e.g., [normal, whisper, shouting, happiness, joy, neutral, sad].

### Assembly and Video

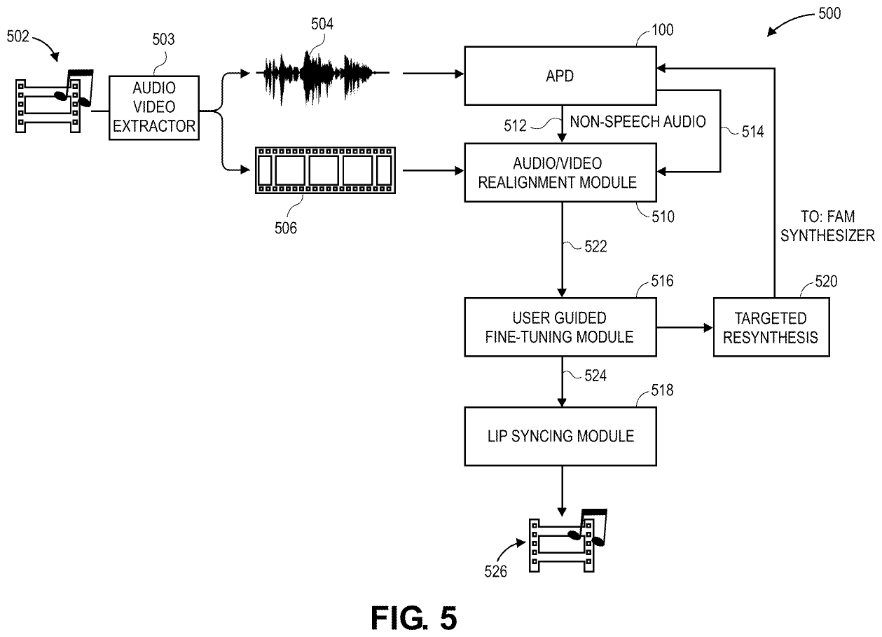

FIG. 5 illustrates a diagram of an audio and video synthesis pipeline 500. The input 502 of the pipeline can be audio, video and/or a combination. For the purposes of this description, video refers to a combination of video and audio. A source separator 503 can extract separate audio and video tracks from the input 502. The input 502 can be separated into an audio track 504 and a video track 506. The audio track 504 can be input to the APD 100. The APD 100 can include a number of modules as described above and can be configured based on the application for which the pipeline 500 is used. For example, the pipeline 500 will be described in an application where an input 502 is a video file and is used to synthesize an output where the speakers in the video speak a synthesized version of the original audio in the input 502. The synthesized audio in the pipeline output can be a translation of the original audio in the input 502 into another language or it can be based on any text, related or unrelated to the audio spoken in the input 502. In one example the output of the pipeline is a synthesized audio overlayed in the video from the input 502, where the speakers in the pipeline output speak a modified version of the original audio in the input 502. In this description, the input/output of the pipeline can alternatively be referred to as the source and target. The source and target terminology refer to a scenario where a video, audio, text segment or text file can be the basis for generating fingerprints and synthesizing audio into a target audio track matching or nearly-matching the source audio in the speech characteristics and speaker identity encoded in the fingerprint. In embodiments where an AFPG or encoder is not used, the synthesizer is matching an output audio to a target synthesized audio output. The target output audio can be combined with the original input video 502, replacing the source input audio tracks 504 to generate a target output audio. The terms “source” and “target” can also refer to a source language and a target language. As described earlier, in some embodiments, the source and target are the same language, but in some applications, they can be different languages. The terms “source” and “target” can also refer to matching a synthesized audio to a source speaker's characteristics to generate a target output audio.

The APD 100 can output synthesized audio clips 514 to an audio/video realignment (AVR) module 510. The audio clips 514 can be one clip at a time based on synthesizing a sentence at a time or based on synthesizing any other unit of speech at a time, depending on the configuration of the ADP 100. The AVR module 510 can assemble the individual audio clips 514, potentially combining them with non-speech audio 512 to generate a continuous audio stream. Various applications of reinserting non-speech audio can be envisioned. Examples include, reinserting the non-speech portions directly into the synthesized output. Another example, can be translating or resynthesizing the non-speech audio into an equivalent non-speech audio in another language (e.g., replacing a Japanese “ano” with an English “umm”). Another example includes replacing the original non-speech audio with a pre-recorded equivalent (or modified) non-speech audio, that may or may not have been synthesized using the APD 100. In one embodiment, timing information at sentence level (or other unit of speech) from a transcript of the input audio 504 can be used to reassemble the synthesized audio clips 514 received from the APD 100. Delay information and concatenation can also be used in assembly.

In some embodiments, a context-aware realignment and assembly can be used to make the assembled audio clips merge well and not to stand out as separately uttered sentences. Previous synthesized audio clips can be fed as additional input to the APD models to generate the subsequent clips in the same characteristics as the previous clips, for example to encode the same “tone” of speech in the upcoming synthesized clips as the “tone” in a selected number of preceding synthesized clips (or based on corresponding input clips from the input audio track 504). In some embodiments, the APD models can use a recurrent component, such as long short-term memory network (LSTM) cells to assist with conditioning the APD models to generate the synthesized output clips 514 in a manner that their assembly can generate a continuous and naturally sounding audio stream. The cells can carry states over multiple iterations.

In some embodiments, time-coded transcripts, which may also be useful for generating captioning meta data can be used as additional inputs to the models of the APD 100, including for example, the synthesizer and any translation models if they are used to configure those models to generate synthesized audio (and/or translation) that match or nearly-match the durations embedded in the timing meta data in the transcript. Generating synthesized audio in this manner can also help created a better matching between the synthesized audio and the video in which the synthesized audio is to be inserted.

This approach can be useful anywhere from sentence level (e.g. adding a new loss term to the model objectives that penalizes outputs that are beyond a threshold longer or shorter than a selected duration derived from the timing metadata from the transcript), to individual word level where in one approach one or more AI models can be configured to anticipate a speaker's mouth's movement in an incoming input video track 506, by for example, detecting word-timing cues and matching or near-matching the synthesized speech's word onsets (or other fitting points) to the input video track 506.

In some embodiments, the output 522 of the AVR module 510 can be routed to a user-guided fine-tuning module 516, which can receive inputs from the user and adjust the alignment of the synthesized audio and the video outputted by the AVR module 510. Adjustments can include adjustments related to position of audio relative to the video, but also adjustments to the characteristics of the speech, such as prosody adjustments (e.g., making the speech more or less emotional, happy, sad, humorous, sarcastic, or other characteristics adjustments). The user's requested adjustments can yield a targeted resynthesis 520, which represents a target audio for the models of the APD 100. In some embodiments, the user's adjustments can be an indicator of what can be considered a natural, more realistic sounding speech. Therefore, such user's adjustments can be used as additional feedback parameters for the models of the APD 100. In other embodiments, user-requested adjustments can include audio manipulation requests as may be useful in an audio production environment. Examples include auto-tuning of a voice, voice level adjustments, and others. Such audio production adjustments can also be paired with or incorporated into the functionality of the FAM 122. Depending on the adjustments and configuration of the APD 100, the adjustments can be routed to the FAM 122 and/or the synthesizer 116 to configure the models therein for generating the synthesized audio clips 514 to match or nearly match the targeted resynthesis 520. The output 522 of the AVR module 510 or an output 524 of the user-guided fine-tuning module 516 can include timing and matching meta data of aligning synthesized audio with the input video 506. Either of the outputs 522, or 524 can be the outputs of the pipeline 500.

In some embodiments, a lip-syncing module 518 can generate an adjusted version of the input video clip 504 into which the output 522 or 524 can be inserted. The adjusted version can include video manipulations, such as adjusting facial features, including mouth movements and/or body language to match or nearly match the outputs 522, 524 and the audio therein. In this scenario, the pipeline 500 can output the synthesized audio/video output 526, using the adjusted version of the video.

### Applications

Applications of the described technology can include translation of preexisting content. For example, content creators, such as YouTubers, Podcasters, audio book providers, film and TV creators may have a library of preexisting content in one language, which they may desire to translate into a second language, without having to hire voice actors or utilize traditional dubbing methods.

In one application, the described system can be offered on-demand for small-scale dubbing tasks. Using the fingerprinting approach, zero-shot speaker matching, while not offering the same speaker similarity as a specifically trained model, is possible. A single audio (or video) clip could be submitted together with a target language, and the system returns the synthesized clip in the translated target language. If speaker-matching is not required, speech could be synthesized in one of the training speaker's voices.

For users with a larger content library, from for example, one hour of speech upwards, an additional training/fine-tuning step can be offered, providing the users with a custom version of the synthesizer 116, fine-tuned to their speaker(s) of choice. This can then be applied to a larger content library in an automated way, using a heuristic-based automatic system, or by receiving user interface commands for manual audio/video matching.

Adding a source separation step, which can split an audio clip into speech and non-speech tracks can further increase the type of content the described system can digest. Depending on the hardware running the described system, the synthesis from text to speech with the models can occur in real-time, near real-time or faster. In some examples, synthesizing one second of audio can take one second or less of computational time. On some current hardware, a speedup factor of 10 is possible. The system can potentially be configured to be fast enough to use in live streaming scenarios. As soon as a sentence (or other unit of speech) is spoken, the sentence is transcribed and translated, which can happen near instantaneously, and the synthesizer 116 model(s) can start synthesizing the speech. A delay between original audio and the translated speech can exist from the system having to wait for the original sentence to be completely spoken before the pipeline can start processing. Assuming the average sentence to last around 5 to 10 seconds, real-time or near real-time speech translation with a delay of around 5-20 seconds is possible. Consequently, in some embodiments, the pipeline may be configured to not wait for a full sentence to be provided before starting to synthesize the output. This configuration of the described system is similar to how professional interpreters may not wait for a full sentence to be spoken before translating. Applications of this configuration of the described system can include streamers, live radio and TV, simultaneous interpretation, and others.

Generating fingerprints, using the described technology, can be fairly efficient, for example, on the order of a second or less per fingerprint generation. While the efficiency can be further optimized, these delays are short enough that speaker identity and speech characteristics and/or other model conditionings can be integrated in a real-time pipeline.

In some embodiments, the manual audio/video-matching process of the pipeline can be crowdsourced. Rather than a single operator aligning a particular sentence with the video, a number of remote, on-demand contributors can be each provided with allocated audio alignment tasks and the final alignment can be chosen through a consensus mechanism.

In deep learning systems, the more specialized a model is, the more proficient the model becomes at a particular task, at the tradeoff of becoming less generally applicable to other tasks. If the target task is narrow enough, more specialized models outperform general models. Consequently, pre-trained models that can be swapped out in the larger pipeline can be provided to users of the described system with diverse focus points. For example, models that specialize on particular domains can be provided. Example domains include food, science, comedy content, serious content, specific language pairs (for source and target languages of the pipeline) and other domains.

A particular model architecture of the synthesizer 116 can be arbitrarily swapped out with another model architecture. Even a single architecture can be configured in or initialized in many diverse variants, since models of this kind have numerous tweakable parameters (e.g., discrete ones such as number of layers or size of fingerprint vector dimension, as well as continuous ones such as relative loss-weights, etc.). Furthermore, training data, as well as the training procedure, from staging to hyperparameter settings, can make each model unique. However, in whatever form, the models map the same inputs of text and conditioning information (e.g., speaker identity, language, prosody data, etc.) into a synthesized output audio file.

In one application, the pipeline can be used to apply a first speaker's speech characteristics to a second speaker's voice. This can be useful in scenarios, where the first speaker is the original creator of a video and the second speaker is a professional dubbing or voice actor. The voice actor can provide a video of the first speaker's original video in a second language and the described pipeline can be used to apply the speech characteristics of the first speaker to the dubbed video (a lip-syncing step may also be applied to the synthesized video). In this application, arbitrarily control can exist over the synthesized speech, with respect to the speech characteristics.

One potential limiting factor in this method of using the technology can be scalability, where the ultimate output be limited by availability of human translators and voice actors. A hybrid approach can be used, where an arbitrary single-speaker synthesizer 116 can synthesize speech and apply a voice conversion model fine-tuned on the desired target speaker to convert the speech to the desired speaker's characteristics.

### Video

While it is possible in some embodiments to generate an altered video to match a synthesized audio, in isolation after the audio has been synthesized, in other embodiments, the video and audio generation can occur in tandem to improve the realism of the synthesized video and audio, but to also reduce or minimize the need for altering the original video to match synthesized audio.

Example Audio/Video Pipeline 1—Audio First, Video Second

In one approach, the joint audio/video pipeline can use the audio pipeline outlined above plus modifications to adjust the synthesized audio to fit the video and vice versa. The source video can be split into its visual and auditory components. The audio components are then processed through the audio pipeline above up to the sentence-level synthesis (or other units of speech). In an automated system, the sentence level audio clips can then be stitched together, using heuristics to align the synthesized audio to the video (e.g., in total length, cuts in the video, certain anchor points, and mouth movements). Close caption data can also be used in the stitching process if they are available and relatively accurate.

The synthesizer 116 can receive “settings,” which can configure the models therein to synthesize speech within the parameters defined by the settings. For example, the settings can include a duration parameter (e.g., a value of 1 assigned to “normal” speed speech for a speaker, values less than 1 assigned to sped-up speech and values larger than 1 assigned to slower than normal-pace speech), and an amount of speech variation (e.g., 0 being no variation, making the speech very robotic). The speech variation parameter value can be unbounded at the upper end, and act as a multiplier for a noise vector sampled from a normal distribution. In some embodiments, a speech variation value of 0.6 produces a naturally sounding speech. Using heuristics, the settings, for example, the duration parameter can make different sentences in the target language fit the timing of the source language better in an automated manner.

In a manual or semi-automatic system, a user interface, similar to video editing software can be deployed. The different sentence level audio clips can be overlaid on the video, as determined by a first iteration of a heuristic system. The user can manipulate the audio clips. This can include adjusting the timing of the audio clips, but can also include enabling the user to make complex audio editing revisions to synthesized audio and/or the alignment of the synthesized audio with the video.

The APD 100 and the models therein can be highly variable in the output they generate. Even for the same input due to the random noise being used in the synthesis, the output can be highly variable between the various runs of the models. Each sentence or unit of speech can be synthesized multiple times with different random seeds. The different clips can be presented to the user to obtain a selection of a desirable output clip from the user. In addition, the user can request re-synthesis of a particular audio clip or audio snippet, if none of the provided ones meets the user's requirements. The user request for resynthesis can also include a request for a change of parameter, e.g., speeding up or slowing down the speech, or adding more or less variation in tone, volume or other speech attributes and conditioning. User requested parameter changes can include rearranging the timing of the changes in the audio, video, both and/or the alignment of audio and video as well. For example, in some embodiments, the user can adjust parameters related to adjusting the speaker's mouth movement in a synthesized video that is to receive a synthesized audio overlay.

Example Audio/Video Pipeline 2: End-to-End Audio/Video Synthesis

Another potential approach to producing a more natural synthesized audio and video is to have a joint synthesis model between the audio and video. The joint model can generate the synthesized speech and match a video (original or synthesized) in a single process. Using the joint model, both the audio and the video parts can be conditioned in the model on each other and optimized to joint parameters, achieving joint optimal results. For example, the audio synthesis part can adjust itself to the source video to make the adjustments required to the mouth movements as minimal as possible, similar to how a professional voice actor adjust their speech or mouth movement to match a video. This, in turn, can reduce or minimize video changes that might otherwise be required to fit the synthesized audio into a video track. For example, using this approach video changes, such as mouth or body movement alternations can be reduced or minimized when fitting a synthesized video. This approach can provide a jointly optimized result, between audio and video, rather than having to first optimize for one aspect (audio) and then optimize another aspect (video) while keeping the first aspect fixed. In one embodiment, the joint model can include a neural network, or a deep neural network, trained with a sample video (including both video and audio tracks). The training can include minimizing losses of individual sub-components of the model (audio and video).

### Example Methods

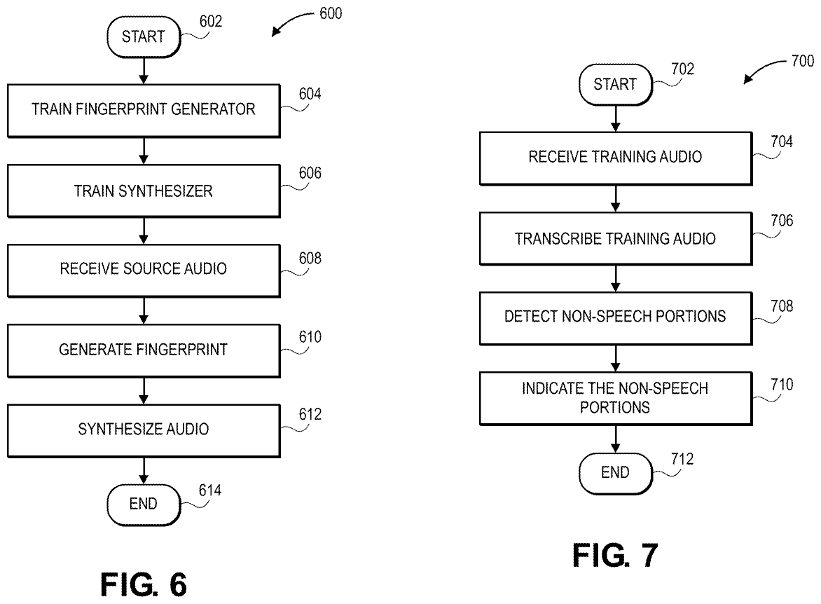

FIG. 6 illustrates an example method 600 of synthesizing audio. The method starts at step 602. At step 604, an AFPG is trained. The training can include receiving a plurality of training natural audio files from one or more speakers, and generating a fingerprint, which encodes speech characteristics and/or identity of the speakers in the training data. As described earlier, the fingerprint can be an entangled or disentangled representation of the various audio characteristics and/or speaker identity in a data structure format, such as a vector. At step 606, a synthesizer is trained by receiving a plurality of training text files, the fingerprint from the step 604 and generating synthesized audio clips, from the training text files. At steps 608-612, inference operations can be used. The trained synthesizer can receive a source audio (e.g., a segment of an audio clip) and/or a source text file. At step 610, the trained fingerprint generator can generate a fingerprint, based on the training at the step 604, or based on a fingerprint generated for the source audio 608. At step 612, the trained synthesizer can synthesize an output audio, based on the fingerprint generated at step 610 and the source text. In some embodiments, the step 608 can be skipped. In other words, the synthesizer can generate an output based on a text file and a fingerprint, where the fingerprint is generated during training operations from a plurality of audio training files. The method ends at step 614.

FIG. 7 illustrates a method 700 of improving the efficiency and accuracy of text to speech systems, such as those described above. The method starts at step 702. At step 704, training audio is received. At step 706, the training audio is transcribed. At step 708, the non-speech portions of the training audio is detected and at step 710, the non-speech portions are indicated in the transcript, for example, by use of selected characters. In some embodiments, the steps 706-710 can occur simultaneously as part of transcribing the training audio. The method ends at step 712.

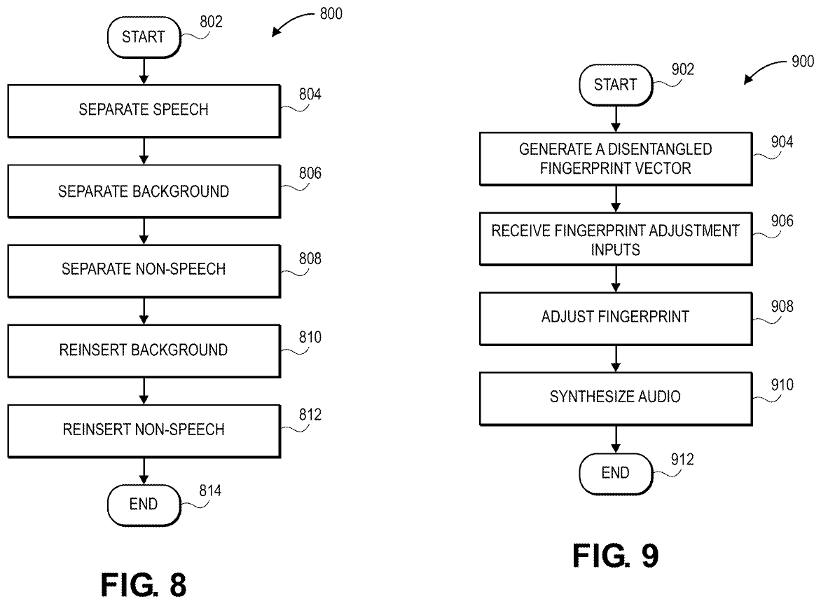

FIG. 8 illustrates a method 800 of increasing the realism of text to speech systems, such as those described above. The method starts at step 802. At step 804, the speech portion of the input audio can be extracted and processed through the APD 100 operations as described above. At step 806, the background portions of the input audio can be extracted. Background portions of an audio clip can refer to environmental audio, unrelated to any speech, such as background music, humming of a fan, background chatter and other noise or non-speech audio. At step 808, the speaker's non-speech sounds are extracted. Non-speech sounds can refer to any human uttered sounds that do not have an equivalent speech. These can include non-verbal sounds, such as laughter, coughing, crying, sneezing or other non-verbal, non-speech sounds. At step 810, the background portions can be inserted in the synthesized audio. At step 812, the non-speech sounds can be inserted in the synthesized audio. One distinction between the steps 810 and 812 include the following. In step 810, the background noise and the synthesized audio are combined by overlaying the two. In step 812, combining the synthesized audio and the non-speech portions include splicing the synthesized speech with the original non-speech audio. The method ends at step 814.

FIG. 9 illustrates a method 900 of generating a synthesized audio using adjusted fingerprints. The method starts at step 902. At step 904, a disentangled fingerprint can be generated, for example, based on the embodiments described above in relation to the FIGS. 1-5. The disentangled fingerprint vector can include dimensions corresponding to distinct and/or overlapping speech characteristics, such as prosody and other speech characteristics. At step 906, a user commends or inputs comprising fingerprint adjustments are received. The user commands may relate to the speech characteristics, and not the parameters and dimensions of the fingerprint. For example, the user may request the synthesized audio to be louder, have more humor, have increased or decreased tempo and/or have any other adjustments to prosody and/or other speech characteristics. At step 908, the dimensions and parameters corresponding to the user requests are adjusted accordingly to match, near match or approximate the user requested adjustments. At step 910, the synthesizer 116 can use the adjusted fingerprint to generate a synthesized audio. The method ends at step 912.

### Example Implementation Mechanism—Hardware Overview

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

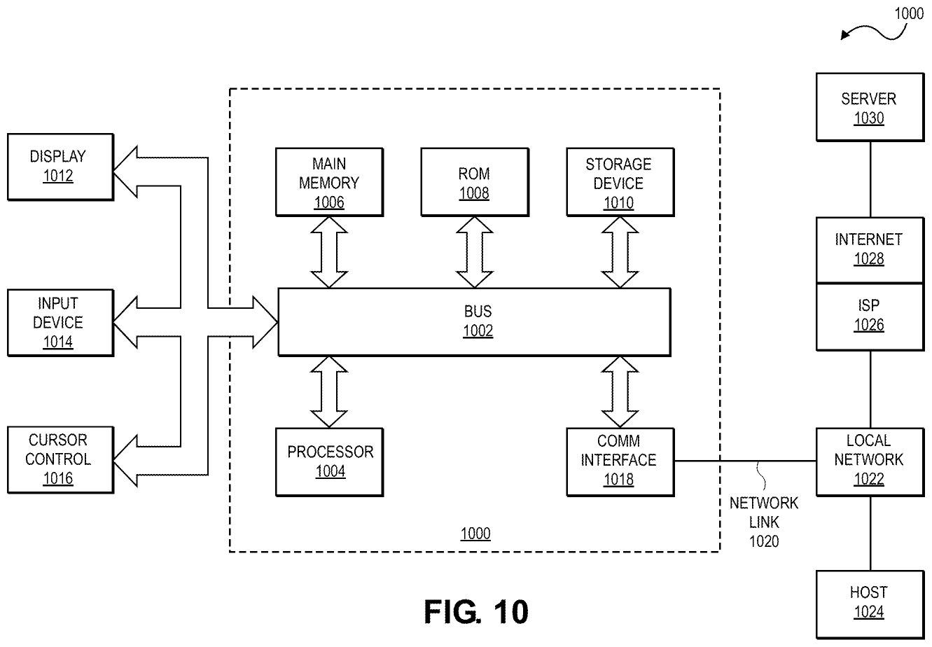

For example, FIG. 10 is a block diagram that illustrates a computer system 1000 upon which an embodiment of can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted or received in video conferencing architectures.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions.

Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, graphical processing units (GPUs), firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### EXAMPLES

It will be appreciated that the present disclosure may include any one and up to all of the following examples.

Example 1: A method comprising: training one or more artificial intelligence models, the training comprising: receiving one or more training audio files; training a fingerprint generator to receive an audio segment of the training audio files and generate a fingerprint for the audio segment, wherein the fingerprint encodes one or more of speaker identity and audio characteristics of the speaker; receiving a plurality of training text files associated with the training audio files; training a synthesizer to receive a text segment of the training text files, a fingerprint, and a target language and generate a target audio, the target audio comprising the text segment spoken in the target language with the speaker identity and the audio characteristics encoded in the fingerprint; using the trained artificial intelligence models to perform inference operations comprising: receiving a source audio segment and a source text segment; generating a fingerprint from the source audio segment; receiving a target language; generating a target audio segment in the target language with the audio characteristics encoded in the fingerprint.

Example 2: The method of Example 1, wherein speaker identity comprises invariant attributes of audio in an audio segment and the audio characteristics comprise variant attributes of audio in the audio segment.

Example 3: The method of one or both of Examples 1 and 2, wherein generating the target audio further includes embedding speaker identity in the target audio when generating the target audio.

Example 4: The method of some or all of Examples 1-3, wherein the source audio segment is in the same language as the target language.

Example 5: The method of some or all of Examples 1-4, wherein the source text segment is a translation of a transcript of the source audio segment into the target language.

Example 6: The method of some or all of Examples 1-5, wherein receiving the training text files comprises receiving a transcript of the training audio files, and the method further comprises: detecting non-speech portions of the training audio files; and identifying corresponding non-speech portions of the training audio files in the transcript; indicating the transcript non-speech portions by one or more selected non-speech characters, wherein the training of the fingerprint generator and the synthesizer comprises training the fingerprint generator and the synthesizer to ignore the non-speech characters.

Example 7: The method of some or all of Examples 1-6, wherein receiving the training text files comprises receiving a transcript of the training audio files, and the method further comprises: detecting non-speech portions of the training audio files; and identifying corresponding non-speech portions of the training audio files in the transcript; indicating the transcript non-speech portions by one or more selected non-speech characters, wherein the training of the fingerprint generator and the synthesizer comprises training the fingerprint generator and the synthesizer to use the non-speech characters to improve accuracy of the generated target audio.

Example 8: The method of some or all of Examples 1-7, wherein training the synthesizer comprises one or more artificial intelligence networks generating language vectors corresponding to the target languages received during training, and wherein generating the target audio segment in the target language during inference operations comprises applying a learned language vector corresponding to the target language.

Example 9: The method of some or all of Examples 1-8, further comprising: separating speech and background portions of the source audio, and using the speech portions in the training and inference operations to generate the target audio segment; and combining the background portions of the source audio segment with the target audio segment.

Example 10: The method of some or all of Examples 1-9, further comprising: separating speech and non-speech portions of a speaker in the source audio segment, and using the speech portions in the training and inference operations to generate the target audio segment; and reinserting the non-speech portions of the source audio into the target audio segment.

Example 11: The method of some or all of Examples 1-10, wherein the fingerprint generator is configured to encode an entangled representation of the audio characteristics into a fingerprint vector, or an unentangled representation of the audio characteristics into a fingerprint vector.

Example 12: The method of some or all of Examples 1-11, wherein training the fingerprint generator comprises providing undefinable audio characteristics to one or more artificial intelligence models of the generator to learn the definable audio characteristics from the plurality of the audio files and encode the undefinable audio characteristics into the fingerprint, and wherein training the synthesizer comprises providing a definable audio characteristics vector to one or more artificial intelligence models of the synthesizer to condition the models of the synthesizer to generate the target audio segment, based at least in part on the definable audio characteristics.

Example 13: The method of some or all of Examples 1-12, wherein the training operations of the fingerprint generator and the synthesizer comprises an unsupervised training, wherein the fingerprint generator training comprises receiving an audio sample; generating a fingerprint encoding speech characteristics of the audio sample; and the synthesizer training comprises receiving a target language and a transcript of the audio sample; and reconstructing the audio sample from the transcript.

Example 14: The method of some or all of Examples 1-13, further comprising receiving one or more fingerprint adjustment commands from a user, the adjustments corresponding to one or more audio characteristics; and modifying the fingerprint based on the adjustment commands.

Example 15: The method of some or all of Examples 1-14, wherein the source audio segment is extracted from a source video segment and the method further comprises replacing the source audio segment in the source video segment with the target audio.

Example 16: The method of some or all of Examples 1-15, wherein the source audio segment is extracted from a source video segment and the method further comprises generating a target video by modifying a speaker's appearance in the source video and replacing the source audio segment in the target video segment with the target audio.

Example 17: The method of some or all of Examples 1-16, wherein the synthesizer is further configured to generate the target audio based at least in part on a previously generated target audio.

Example 18: The method of some or all of Examples 1-17, wherein distance between two fingerprints is used to determine speaker identity.

Example 19: The method of some or all of Examples 1-18, wherein a fingerprint for a speaker in an audio segment is generated based at least in part on a nearby fingerprint of another speaker in another audio segment.

Example 20: The method of some or all of Examples 1-19, wherein the fingerprint comprises a vector representing the audio characteristics, wherein subspaces of dimensions of the vector correspond to one or more distinct or overlapping audio characteristics, wherein dimensions within a subspace do not necessarily correspond with human-definable audio characteristics.

Example 21: The method of some or all of Examples 1-20, wherein the fingerprint comprises a vector representing the audio characteristics distributed over some or all dimensions of the fingerprint vector.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed is:

1. A method comprising:
training one or more artificial intelligence models, the training comprising:
receiving one or more training audio files;
training a fingerprint generator to receive an audio segment of the training audio files and generate a fingerprint for the audio segment, wherein the fingerprint encodes one or more of speaker identity and audio characteristics of the speaker;
receiving a plurality of training text files associated with the training audio files;
training a synthesizer to receive a text segment of the training text files, a fingerprint, and a target language and generate a target audio, the target audio comprising the text segment spoken in the target language with the speaker identity and the audio characteristics encoded in the fingerprint;
using the trained artificial intelligence models to perform inference operations comprising:
receiving a source audio segment and a source text segment;
generating a fingerprint from the source audio segment;
receiving a target language;
generating a target audio segment in the target language with the audio characteristics encoded in the fingerprint.

2. The method of claim 1, wherein speaker identity comprises invariant attributes of audio in an audio segment and the audio characteristics comprise variant attributes of audio in the audio segment.

3. The method of claim 1, wherein generating the target audio further includes embedding speaker identity in the target audio when generating the target audio.

4. The method of claim 1 wherein the source audio segment is in the same language as the target language.

5. The method of claim 1, wherein the source text segment is a translation of a transcript of the source audio segment into the target language.

6. The method of claim 1, wherein receiving the training text files comprises receiving a transcript of the training audio files, and the method further comprises:
detecting non-speech portions of the training audio files; and
identifying corresponding non-speech portions of the training audio files in the transcript;
indicating the transcript non-speech portions by one or more selected non-speech characters, wherein the training of the fingerprint generator and the synthesizer comprises training the fingerprint generator and the synthesizer to ignore the non-speech characters.

7. The method of claim 1, wherein receiving the training text files comprises receiving a transcript of the training audio files, and the method further comprises:
detecting non-speech portions of the training audio files; and
identifying corresponding non-speech portions of the training audio files in the transcript;
indicating the transcript non-speech portions by one or more selected non-speech characters, wherein the training of the fingerprint generator and the synthesizer comprises training the fingerprint generator and the synthesizer to use the non-speech characters to improve accuracy of the generated target audio.

8. The method of claim 1, wherein training the synthesizer comprises one or more artificial intelligence networks generating language vectors corresponding to the target languages received during training, and wherein generating the target audio segment in the target language during inference operations comprises applying a learned language vector corresponding to the target language.

9. The method of claim 1, further comprising:
separating speech and background portions of the source audio, and using the speech portions in the training and inference operations to generate the target audio segment; and
combining the background portions of the source audio segment with the target audio segment.

10. The method of claim 1, further comprising:
separating speech and non-speech portions of a speaker in the source audio segment, and using the speech portions in the training and inference operations to generate the target audio segment; and
reinserting the non-speech portions of the source audio into the target audio segment.

11. The method of claim 1, wherein the fingerprint generator is configured to encode an entangled representation of the audio characteristics into a fingerprint vector, or an unentangled representation of the audio characteristics into a fingerprint vector.

12. The method of claim 1,
wherein training the fingerprint generator comprises providing undefinable audio characteristics to one or more artificial intelligence models of the generator to learn the definable audio characteristics from the plurality of the audio files and encode the undefinable audio characteristics into the fingerprint, and
wherein training the synthesizer comprises providing a definable audio characteristics vector to one or more artificial intelligence models of the synthesizer to condition the models of the synthesizer to generate the target audio segment, based at least in part on the definable audio characteristics.

13. The method of claim 1,
wherein the training operations of the fingerprint generator and the synthesizer comprises an unsupervised training, wherein the fingerprint generator training comprises receiving an audio sample; generating a fingerprint encoding speech characteristics of the audio sample; and
the synthesizer training comprises receiving a target language and a transcript of the audio sample; and
reconstructing the audio sample from the transcript.

14. The method of claim 1, further comprising receiving one or more fingerprint adjustment commands from a user, the adjustments corresponding to one or more audio characteristics; and modifying the fingerprint based on the adjustment commands.

15. The method of claim 1, wherein the source audio segment is extracted from a source video segment and the method further comprises replacing the source audio segment in the source video segment with the target audio.

16. The method of claim 1, wherein the source audio segment is extracted from a source video segment and the method further comprises generating a target video by modifying a speaker's appearance in the source video and replacing the source audio segment in the target video segment with the target audio.

17. The method of claim 1, wherein the synthesizer is further configured to generate the target audio based at least in part on a previously generated target audio.

18. The method of claim 1, wherein distance between two fingerprints is used to determine speaker identity.

19. The method of claim 1, wherein a fingerprint for a speaker in an audio segment is generated based at least in part on a nearby fingerprint of another speaker in another audio segment.

20. The method of claim 1, wherein the fingerprint comprises a vector representing the audio characteristics, wherein subspaces of dimensions of the vector correspond to one or more distinct or overlapping audio characteristics, wherein dimensions within a subspace do not necessarily correspond with human-definable audio characteristics.

21. The method of claim 1, wherein the fingerprint comprises a vector representing the audio characteristics distributed over some or all dimensions of the fingerprint vector.
